(19) United States
(12) Patent Application Publication
(10) Pub. No.: US 2023/0316464 A1
(43) Pub. Date: Oct. 5, 2023

(54) VIRTUAL VIEW DRAWING METHOD AND APPARATUS, RENDERING METHOD AND APPARATUS, AND DECODING METHOD AND APPARATUS, AND DEVICES AND STORAGE MEDIUM

(71) Applicant: GUANGDONG OPPO MOBILE TELECOMMUNICATIONS CORP., LTD., Dongguan (CN)

(72) Inventors: You YANG, Dongguan (CN); Yongquan SU, Dongguan (CN); Qiong LIU, Dongguan (CN); Kejun WU, Dongguan (CN); Ze CHEN, Dongguan (CN)

(21) Appl. No.: 18/207,982

(22) Filed: Jun. 9, 2023

Related U.S. Application Data
(63) Continuation of application No. PCT/CN2020/135779, filed on Dec. 11, 2020.

(51) Int. Cl. G06T 5/00; G06T 15/04; G06T 7/50; G06T 7/11; G06T 15/10; G06T 9/00

(52) U.S. Cl. CPC G06T 5/002; G06T 15/04; G06T 7/50; G06T 7/11; G06T 15/10; G06T 9/00; G06T 2207/20192

(57) ABSTRACT

A virtual view drawing method and apparatus, a rendering method and apparatus, and a decoding method and apparatus, and devices and a storage medium are provided. The virtual view drawing method comprises: generating an initial visibility map of a target view according to reconstructed depth maps of source views; performing quality improvement processing on the initial visibility map to obtain a target visibility map of the target view; and coloring the target visibility map of the target view to obtain a target texture map of the target view.

### CROSS-REFERENCE TO RELATED APPLICATION

This is a continuation of International Application No. PCT/CN2020/135779, filed on Dec. 11, 2020, entitled “VIRTUAL VIEW DRAWING METHOD AND APPARATUS, RENDERING METHOD AND APPARATUS, AND DECODING METHOD AND APPARATUS, AND DEVICES AND STORAGE MEDIUM”, which is hereby incorporated by reference in its entirety.

### BACKGROUND

Most users prefer to watch immersive video contents (such as virtual reality contents, three-dimensional contents, 180-degree contents or 360-degree contents), which can provide an immersive experience for viewers. In addition, these users may like to watch computer-generated contents in an immersive format, such as game videos or animations.

However, at an encoding end, compression distortion is very serious due to some errors in depth values of some pixels in a depth map and a quantization parameter with a larger value used to compress and encode the depth map. In view of this, at a decoding end, quality of the depth map recovered by decoding will be greatly reduced, which will lead to obvious noise appeared in the generated depth map of a target viewport, and edges of the depth map do not completely coincide with edges of actual textures. One of the manifestations reflected in a texture map is that there is a transition zone at a junction of foreground and background, and foreground edges are not steep enough.

### SUMMARY

Embodiments of the present disclosure relate to computer vision technologies, and relate to but are not limited to a method of virtual viewport drawing, a rendering method, a decoding method, an apparatus of virtual viewport drawing, a rendering apparatus, a decoding apparatus, a device and a storage medium.

The method of virtual viewport drawing, the rendering method, the decoding method, the apparatus of virtual viewport drawing, the rendering apparatus, the decoding apparatus, the device and the storage medium provided by embodiments of the present disclosure are realized as follows.

An embodiment of the present disclosure provides a method of virtual viewport drawing, which includes following operations. An initial visibility map of a target viewport is generated according to reconstructed depth maps of source viewports. Quality improvement processing is performed on the initial visibility map to obtain a target visibility map of the target viewport. The target visibility map of the target viewport is shaded to obtain a target texture map of the target viewport.

An embodiment of the present disclosure provides a rendering method, which includes the following operations. Pruned view reconstruction is performed on atlases of depth maps of source viewports to obtain reconstructed depth maps of the source viewports. Operations in the method of virtual viewport drawing according to the embodiment of the present disclosure are performed on the reconstructed depth maps of the source viewports to obtain a target texture map of a target viewport. A target view of the target viewport is generated according to the target texture map of the target viewport.

An embodiment of the present disclosure provides a decoding method, which includes the following operations. An input bitstream is decoded to obtain atlases of depth maps of source viewports. Pruned view reconstruction is performed on the atlases of the depth maps of the source viewports to obtain reconstructed depth maps of the source viewports. The operations in the method of virtual viewport drawing according to the embodiment of the present disclosure is performed on the reconstructed depth maps of the source viewports to obtain a target texture map of a target viewport. A target view of the target viewport is generated according to the target texture map of the target viewport.

An embodiment of the present disclosure provides an apparatus of virtual viewport drawing, which includes a visibility map generation module, a visibility map optimization module and a shading module. The visibility map generation module is configured to generate an initial visibility map of a target viewport according to reconstructed depth maps of source viewports. The visibility map optimization module is configured to perform quality improvement processing on the initial visibility map to obtain a target visibility map of the target viewport. The shading module is configured to shade the target visibility map of the target viewport to obtain a target texture map of the target viewport.

An embodiment of the present disclosure provides a rendering apparatus, which includes: a pruned view reconstruction module, a virtual viewport drawing module and a target view generation module. The pruned view reconstruction module is configured to perform pruned view reconstruction on atlases of depth maps of source viewports to obtain reconstructed depth maps of the source viewports. The virtual viewport drawing module is configured to perform operations in the method of virtual viewport drawing described in the embodiment of the present disclosure on the reconstructed depth maps of the source viewports to obtain a target texture map of a target viewport. The target view generation module is configured to generate a target view of the target viewport according to the target texture map of the target viewport.

An embodiment of the present disclosure provides a decoding apparatus, which includes a decoding module, a pruned view reconstruction module, a virtual viewport drawing module and a target view generation module. The decoding module is configured to decode an input bitstream to obtain atlases of depth maps of source viewports. The pruned view reconstruction module is configured to perform pruned view reconstruction on the atlases of the depth maps of the source viewports to obtain reconstructed depth maps of the source viewports. The virtual viewport drawing module is configured to perform operations in the method of virtual viewport drawing according to an embodiment of the present disclosure on the reconstructed depth map of the source viewports to obtain a target texture map of a target viewport. The target view generation module is configured to generate a target view of the target viewport according to the target texture map of the target viewport.

An embodiment of the present disclosure provides a View Weighting Synthesizer (VWS), which is configured to implement the method of virtual viewport drawing according to the embodiment of the present disclosure.

An embodiment of the present disclosure provides a rendering device which is configured to implement the rendering method according to the embodiment of the present disclosure.

An embodiment of the present disclosure provides a decoder, which is configured to implement the decoding method according to the embodiment of the present disclosure.

An embodiment of the present disclosure provides an electronic device, which includes a memory and a processor. The memory stores a computer program executable by the processor, and the processor implements any method described in the embodiment of the present disclosure when executing the computer program.

An embodiment of the present disclosure provides a computer readable storage medium on which a computer program is stored, and the computer readable storage medium, when executed by a processor, implements any method described in the embodiment of the present disclosure.

### BRIEF DESCRIPTION OF THE DRAWINGS

The accompanying drawings, which are incorporated in and constitute a part of the specification, illustrate embodiments consistent with the application and together with the description serve to explain the technical aspects of the present disclosure.

FIG. 1 is a diagram of system architecture to which embodiments of the present disclosure may be applied.

FIG. 2 is a diagram of a structure of a VWS.

FIG. 3 is a flow diagram of a calculation of a weight value of a not pruned pixel.

FIG. 4 is a comparison diagram of a depth map obtained by depth estimation and a depth map generated by a VWS.

FIG. 5 is a comparison diagram of an edge of a depth map and an edge of a texture map generated by a VWS.

FIG. 6 is a flow diagram of an implementation of a method of virtual viewport drawing according to an embodiment of the present disclosure.

FIG. 7 is a flow diagram of an implementation of a method of virtual viewport drawing according to an embodiment of the present disclosure.

FIG. 8 is a diagram of an initial visibility map.

FIG. 9 is a flow diagram of an implementation of a method of virtual viewport drawing according to an embodiment of the present disclosure.

FIG. 10 is a flow diagram of an implementation of a method of virtual viewport drawing according to an embodiment of the present disclosure.

FIG. 11 is a flow diagram of an implementation of a method of virtual viewport drawing according to an embodiment of the present disclosure.

FIG. 12 is a flow diagram of a depth map optimization technique in view generation by adopting superpixel segmentation in an embodiment of the present disclosure.

FIG. 13 is a diagram of system architecture with a depth map optimization technique being introduced according to an embodiment of the present disclosure.

FIG. 14 is a comparison diagram of two depth maps generated by using a test sequence of a Fencing scene.

FIG. 15 is a comparison diagram of two depth maps generated by using a test sequence of a Frog scene.

FIG. 16 is a comparison diagram of two texture maps generated by using a Fencing test sequence.

FIG. 17 is a comparison diagram of two texture maps generated by using a Frog test sequence.

FIG. 18 is a comparison diagram of two texture maps generated by using a test sequence of a Carpark scene.

FIG. 19 is a comparison diagram of two texture maps generated by using a test sequence of a Street scene.

FIG. 20 is a comparison diagram of two texture maps generated by using a test sequence of a Painter scene.

FIG. 21 is a structural diagram of an apparatus of virtual viewport drawing according to an embodiment of the present disclosure.

FIG. 22 is a structural diagram of a rendering apparatus according to an embodiment of the present disclosure.

FIG. 23 is a structural diagram of a decoding apparatus according to an embodiment of the present disclosure.

FIG. 24 is a diagram of hardware entities of an electronic device according to an embodiment of the present disclosure.

### DETAILED DESCRIPTION

In order to make the purpose, technical solutions, and advantages of the embodiments of the present disclosure clearer, specific technical solutions of the present disclosure will be further described in detail with reference to the accompanying drawings in the embodiments of the present disclosure. The following embodiments are used to describe the present disclosure rather than limiting the scope of the present disclosure.

Unless otherwise defined, all technical and scientific terms used herein shall have the same meanings as commonly understood by those skilled in the art to which the present disclosure belongs. The terms used herein are only intended to describe the embodiments of the present disclosure, and are not intended to limit the present disclosure.

“Some embodiments” involved in the following descriptions describes a subset of all possible embodiments. However, it can be understood that “some embodiments” may be the same subset or different subsets of all the possible embodiments, and may be combined without conflicts.

It should be pointed out that, the term “first/second/third” involved in the description below is only for distinguishing similar objects and does not represent a specific sequence of the objects. It can be understood that “first/second/third” may be interchanged to specific sequences or orders if allowed to implement the embodiments of the present disclosure described herein in sequences except the illustrated or described ones.

The system architecture and the service scenario described in embodiments of the present disclosure are intended to more clearly explain the technical solution of embodiments of the present disclosure, and do not constitute a limitation to the technical solution provided by embodiments of the present disclosure. As those skilled in the art can see, with the evolution of the system architecture and the emergence of new business scenarios, the technical solution provided by embodiments of the present disclosure is equally applicable to similar technical problems.

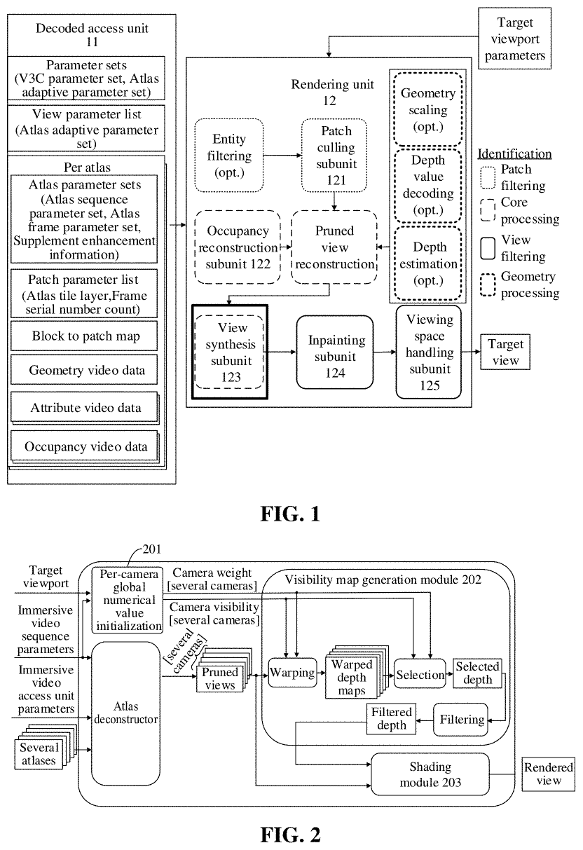

FIG. 1 illustrates system architecture to which embodiments of the present disclosure may apply, i.e., system architecture 10 of a decoding end of a 3 degrees of freedom+(3DoF+) Test Model of Immersive Video (TMIV) of a Moving Picture Experts Group (MPEG). As illustrated in FIG. 1, the system architecture 10 includes a decoded access unit 11 and a rendering unit 12. The decoded access unit 11 includes various types of metadata and the atlas information obtained after decoding. This information in the decoded access unit 11 will then be transmitted to the rendering unit 12 for virtual viewport drawing. Subunits marked with ‘opt.’ denote optional subunits, which are not described herein because they are not mentioned in the technical solution of embodiments of the present disclosure for the time being. A patch culling subunit 121 of the rendering unit 12 selects patches in atlas information according to user target viewport parameters, and eliminates patches that do not overlap with a user target view, thereby reducing the amount of calculation at the time of virtual viewport drawing. An occupancy map restoration subunit 122 (i.e., occupancy map reconstruction subunit) of the rendering unit 12 finds out a respective position of each patch in a view based on the information transmitted from the decoded access unit 11, and then pastes the selected patches into the corresponding position to complete the pruned view restoration (i.e., pruned view reconstruction). A view generation subunit 123 (i.e., view synthesis unit), by using the reconstructed pruned view described above, performs virtual viewport drawing, i.e., drawing of a target viewport. Since the generated virtual viewport has a certain hole region, an inpainting subunit 124 is required to inpaint the hole. Finally, a viewing space handling subunit 125 may cause the view to fade smoothly as black.

Viewport Weighted Synthesizer (VWS) is a virtual viewport drawing tool used by the MPEG in the 3DoF+ TMIV. The VWS is used in a renderer on the decoding end, specifically in a view synthesis part after a pruned view reconstruction subunit 126.

As illustrated in FIG. 2, in the related art, the VWS mainly includes three modules: a weight calculation module 201, a visibility map generation module 202 and a shading module 203. The visibility map generation module 202 is used to generate a visibility map under a target viewport and the shading module 203 is used to shade the generated visibility map under the target viewport, so as to obtain a texture map under the target viewport. Since the visibility map generation module 202 and the shading module 203 depend on a weight value of a source viewport with respect to the target viewport, the weight calculation module 201 is used to calculate the weight value of the source viewport according to a relationship between the source viewport and the target viewport.

1) Relevant contents of the weight calculation module 201 are described as follows.

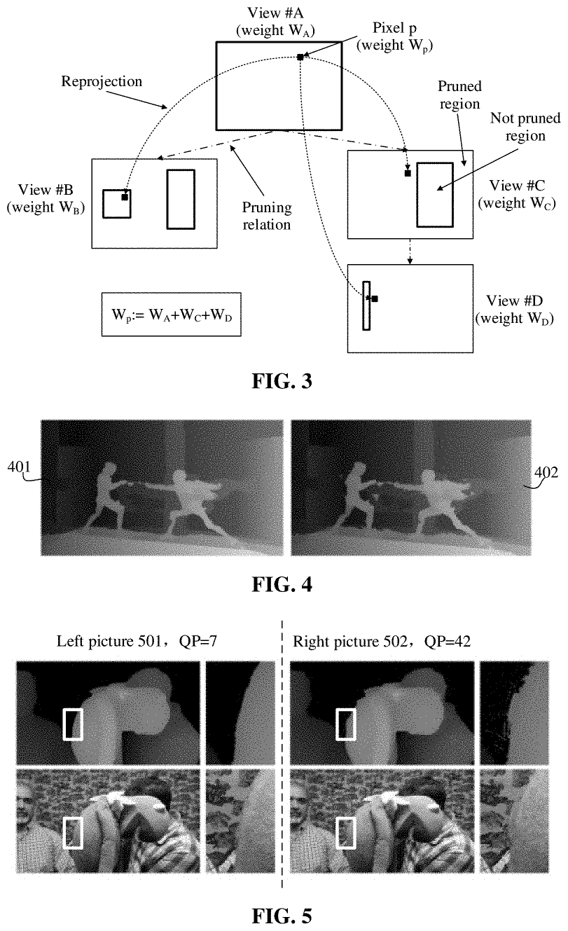

The weight calculation module 201 calculates the weight value of the source viewport based on metadata information of the source viewport and metadata information of the target viewport. The weight value of the source viewport is a function of a distance between the source viewport and the target viewport. In a calculation and shading processing of the visibility map, a contribution of related pixels to a result is a weight value of contributions of viewports corresponding to the related pixels. When handling with a pruned view, due the incomplete content of the pruned view, an image region that is pruned needs to be considered when calculating a weight value of the pruned view. A weight calculation is a pixel-level operation, which calculates a weight corresponding to a not pruned pixel. The weight value of the pixel is updated when the viewport is generated. As illustrated in FIG. 3, a weight value of a not pruned pixel is calculated according to following operations.

For a not pruned pixel p in a view associated with a node N in a pruned map, an initial weight value of the pixel p w_{P} equals to w_{N} (i.e., w_{P}=w_{N}). It should be noted that, the initial weight value of the pixel p is a weight value of a viewport to which the pixel p belongs, and the weight value of the pixel p depends on a distance between the viewport to which the pixel p belongs and the target viewport. The weight value of the pixel p is then updated by using processes a to c described below.

a. If the pixel p is re-projected to a child node view, and the pixel p after re-projection corresponds to a pruned pixel in the child node view, the weight value of the pixel p is updated to a weight wₒ of the child node view plus the initial weight value of the pixel p, i.e., wₚ=wₚ+wₒ. It should be noted that, the weight value of the child node view depends only on a distance between a viewport in which the child node view located and the target viewport. Then, the above operation is continued to be performed on a grandchild node of the pixel p.

b. If the pixel p after re-projection does not correspond to the child node view of the pixel p, the above operation is recursively performed on the grandchild node of the pixel p.

c. If the pixel p after re-projection corresponds to a not pruned pixel is in the child node view of the pixel p, the weight value of the pixel p is unchanged, and the above operation is no longer performed on the grandchild node of the pixel p.

2) Related contents of the visibility map generation module 202 are described as follows.

The purpose of calculating the visibility map is to obtain a visibility map under a target viewport based on restored depth maps (i.e., the reconstructed depth maps) of the source viewports. The whole process is divided into three operations: warping, selecting and filtering.

In the warping operation, pixels in the depth maps of the source viewports are re-projected to the target viewport to generate wrapped depth maps. By performing this operation on the source viewports, several wrapped depth maps under the target viewport are obtained.

In the selecting operation, the several wrapped depth maps are merged to generate a relatively complete depth map under the target viewport, i.e., a visibility map. The selecting operation is carried out according to the weight value of each source viewport and by using a majority voting principle based on pixel level. The majority voting principle means that there may be multiple depth values projected to the same pixel position, and a depth value projected most is selected.

Finally, the filtering operation is performed on the generated visibility map. A median filter is used to remove outliers.

3) Relevant contents of the shading module 203 are described as follows.

The purpose of this operation is to generate the texture map under the target viewport. In order to generate the texture map under the target viewport, the filtered visibility map and the restored texture maps of the source viewports are required. In this process, it is required to consider the continuity of pixels in the source viewports in the visibility map and the weights of the viewports to which the pixels belong. In order to improve the visual quality of the generated texture content, bilinear filtering is used to process the generated texture map. In addition, in order to avoid aliasing, the detected pixels from edges of objects in the texture maps of the source viewports need to be culled.

Due to the immature depth acquisition technology and expensive equipment, related solutions mostly use a method of obtaining a depth map by performing texture acquisition before performing depth estimation. However, the inventor found following problems in the research process.

There are some errors in depth values calculated by depth estimation method, which leads to the existence of noises in the estimated depth map. Therefore, some noises inevitably exist in a depth map of the target viewport generated by performing virtual viewport drawing by using the estimated depth map. For example, as illustrated in FIG. 4, a left picture 401 is a depth map obtained by using depth estimation, and a right picture 402 is a depth map obtained by performing virtual viewport drawing by using the left picture 401. This is to say, the right picture 402 is a depth map generated by the VWS. As can be seen from the pictures 401 and 402, there is more noises in the right picture 402.

Before an encoding end compresses a depth map, it is usually required to down-sample the depth map to reduce the resolution. The depth map is usually compressed by using video encoding standards. After compression and encoding, certain compression distortion occurs on the depth map. Especially, when a quantization parameter (QP) with a larger value is used to compress the depth map, the compression distortion will be more serious. Based on the above analysis, the inventor found in the research process that at the decoding end, the quality of the decoded and restored depth map will be greatly reduced, resulting in obvious noises occurring in the generated depth map of the target viewport, and edges of the depth map do not completely coincide with edges of actual textures. One of the manifestations reflected in a texture map is that there is a transition band at a junction of foreground and background, and foreground edges are not steep enough.

For example, as illustrated in FIG. 5, the left picture 501 shows an effect of compressing a depth map by using a quantization parameter with a value of 7 (i.e., QP=7), and the right picture 502 shows an effect of compressing a depth map by using a quantization parameter with a value of 42 (i.e., QP=42). It can be seen from FIG. 5 that an image 5021 in a white rectangular frame in the right picture 502 has more noises, which are reflected as a large transition band at a junction of the foreground and the background in an image area 5022 in the texture map.

Because of the compression distortion of the depth map, the quality of the depth map and the texture map generated by the VWS will be degraded. Therefore, in order to generate high-quality depth map and texture map, it is required to compress the depth map by using a QP with a value as small as possible. In view of this, the compression degree of the depth map is limited, which leads to the increase of coding overhead of the depth map, reduces coding efficiency, and objectively reduces the overall compression and coding efficiency of “multi-view video and multi-view depth”.

In view of this, an embodiment of the present disclosure provides a method of virtual viewport drawing, which can be applied to any electronic device with data processing capability, and the electronic device can be any device with a video coding and decoding function or only a decoding function, such as a television, a projector, a mobile phone, a personal computer, a tablet computer, a virtual reality (VR) head-mounted device, etc. The function implemented by the method of the virtual viewport drawing can be implemented by a processor in the electronic device through invoking program codes. Of course, the program codes can be stored in a computer storage medium. As can be seen, the electronic device includes at least the processor and the storage medium.

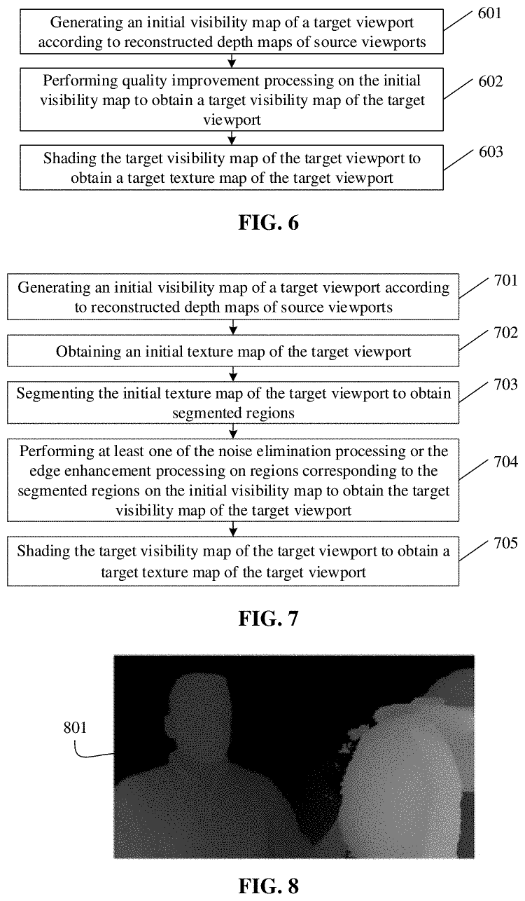

FIG. 6 is a flow diagram of an implementation of a method of virtual viewport drawing according to an embodiment of the present disclosure. As illustrated in FIG. 6, the method may include following operations 601 to 603.

At an operation 601, an initial visibility map of a target viewport is generated according to reconstructed depth maps of source viewports.

It can be understood that, in a case that there are reconstructed depth maps of at least one source viewport, the electronic device can generate the initial visibility map of the target viewport based on the reconstructed depth maps of these source viewports. In some embodiments, the electronic device may obtain the initial visibility map through the visibility map generation module 202 as illustrated in FIG. 2.

It should be noted that, the visibility map and the depth map have the same meaning, which both indicate a distance between a scene and a camera position. The visibility map is different from the depth map in that the closer to the camera position in the visibility map, the smaller the pixel value.

At an operation 602, quality improvement processing is performed on the initial visibility map to obtain a target visibility map of the target viewport.

The purpose of the quality improvement processing is to reduce noises and/or transition zones in the initial visibility map. In some embodiments, the electronic device may perform at least one of noise elimination processing or edge enhancement processing on the initial visibility map to achieve the quality improvement of the initial visibility map, so as to obtain the target visibility map of the target viewport.

It can be understood that, the so-called transition zone refers to a transition band region existing at junctions in an image, which leads to the deviation of the subsequent analysis and understanding of the image, and thereby causing the unnatural transitions at the junctions in a final target view.

The electronic device can perform at least one of noise elimination processing or edge enhancement processing on the initial visibility map in a variety of ways. For example, the electronic device performs filtering processing on the initial visibility map. For another example, the electronic device performs replacement processing on pixel values at noises and transition zones existing in the initial visibility map.

At an operation 603, the target visibility map of the target viewport is shaded to obtain a target texture map of the target viewport.

In the embodiment of the present disclosure, the electronic device generates the initial visibility map of the target viewport according to the reconstructed depth maps of the source viewports. After this operation, instead of directly generating the target texture map of the target viewport from the initial visibility map of the target viewport, quality improvement processing is performed on the initial visibility map at first, and the target texture map is obtained by shading the processed initial visibility map. In this way, on the one hand, the noises and/or transition zones in the target texture map are obviously reduced. On the one hand, on the basis of ensuring the image quality of the target texture map, the encoding end can use a quantization parameter with a larger value to compress and encode the depth map, and thus reducing the coding overhead of the depth map and improving the overall coding efficiency.

An embodiment of the present disclosure further provides a method of virtual viewport drawing. FIG. 7 is a flow diagram of an implementation of a method of virtual viewport drawing according to an embodiment of the present disclosure. As illustrated in FIG. 7, the method may include following operations 701 to 705.

At an operation 701, an initial visibility map of a target viewport is generated according to reconstructed depth maps of source viewports.

In some embodiments, the electronic device may decode the input bitstream to obtain atlases of depth maps of source viewports. Then, pruned view reconstruction is performed on the atlases of the depth maps of the source viewports to obtain reconstructed depth maps of the source viewports.

In embodiments of the present disclosure, a number of the source viewports on which the initial visibility map is generated is not limited. The electronic device may generate the initial visibility map of the target viewport from reconstructed depth maps of one or more source viewports.

At an operation 702, an initial texture map of the target viewport is obtained.

In fact, the electronic device decodes the input bitstream to obtain not only the atlases of the depth maps of the source viewports, but also the atlas of the texture maps of the source viewports. Based on this, in some embodiments, the electronic device may obtain the initial texture map of the target viewport through following operations. Pruned view reconstruction is performed on the atlases of the texture maps of the source viewports to obtain reconstructed texture maps of the source viewports; the initial texture map of the target viewport is obtained by shading the initial visibility map of the target viewport according to the reconstructed texture maps of the source viewports.

At an operation 703, the initial texture map of the target viewport is segmented to obtain segmented regions.

It can be understood that, the reason of segmenting the initial texture map instead of segmenting the initial visibility map directly is as follows. If the initial visibility map is segmented directly, as illustrated in FIG. 8, an initial visibility map 801 is segmented very well along edges in the initial visibility map 801. By using this segmentation method, if there are some noises existing on the edges, these noises cannot be segmented. Compared with the segmentation based on the initial visibility map, segmentation based on the initial texture map can make a better division at edges (i.e., at junctions). A more accurate segmentation result obtained by using the initial texture map can better guide the quality improvement processing on the initial visibility map, which will be very beneficial to sharpening the edges. In this way, the noises and transition zones at the edges of the target texture map obtained after performing the quality improvement processing and the shading processing are obviously reduced.

In some embodiments, superpixel segmentation is performed on the initial texture map to obtain segmented regions. It should be noted that the used superpixel segmentation algorithms may be varied and are not limited in the embodiments of the present disclosure. For example, the superpixel segmentation algorithm may be a Simple Linear Iterative Cluster (SLIC) superpixel segmentation algorithm, a Superpixels Extracted via Energy-Driven Sampling (SEEDS) algorithm, a Contour-Relaxed Superpixels (CRS) algorithm, an Efficient topology Preserving Segmentation (ETPS) algorithm or an Entropy Rate Superpixel Segmentation (ERS) algorithm, and the like.

Compared with other superpixel segmentation algorithms, the SLIC superpixel segmentation algorithm is ideal in running speed, compactness of generated superpixels and contour preservation. Therefore, in some embodiments, by performing the superpixel segmentation on the initial texture map by using the SLIC superpixel segmentation algorithm, the electronic device can improve the quality of the target texture map to a certain extent without significantly increasing the processing time, and thereby obviously improving the objective quality and subjective effect of the final obtained target texture map and the obtained target view corresponding to the target texture map.

At an operation 704, at least one of the noise elimination processing or the edge enhancement processing is performed on regions corresponding to the segmented regions on the initial visibility map to obtain the target visibility map of the target viewport.

In some embodiments, the electronic device takes the segmented regions of the initial texture map as segmented regions of the initial visibility map; classifies pixels in the segmented regions of the initial visibility map to determine target pixels to be updated in the segmented regions of the initial visibility map; and updates pixel values of the target pixels in the initial visibility map to obtain the target visibility map.

For example, the determination of the target pixels to be updated may be implemented through following operations 904 and 905 according to the embodiment.

Classification algorithms can be varied. For example, classification algorithms are K-means clustering algorithms, decision tree algorithms, Bayesian algorithms, artificial neural networks, support vector machines or classification based on association rules.

It can be understood that, the scene contents expressed at the same position in the initial visibility map and the initial texture map are consistent. Therefore, the electronic device can directly move a segmentation result of the initial texture map to the initial visibility map. That is to say, the segmented regions of the initial texture map are taken as the segmented regions of the initial visibility map.

There may be a variety of ways to update the pixel values of the target pixels. For example, the electronic device may perform filtering processing on the pixel values of the target pixels in the visibility map to realize the updating of the pixel values. For another example, the electronic device can also replace the pixel values of the target pixels in the visibility map to realize the updating of the pixel values. Each segmented region corresponds to a respective pixel replacement value, which can be a mean value of pixel values of non-target pixels in the segmented region. In a case of using a clustering algorithm, each segmented region corresponds to a respective cluster center of a class of the non-target pixels, so that a pixel value of the cluster center of the non-target pixels can be used as the pixel replacement value.

At an operation 705, the target visibility map of the target viewport is shaded to obtain a target texture map of the target viewport.

The operation 705 can be implemented by the shading module 203 as illustrated in FIG. 2. The target visibility map of the target viewport is shaded according to the reconstructed texture maps of the source viewports to obtain the target texture map of the target viewport.

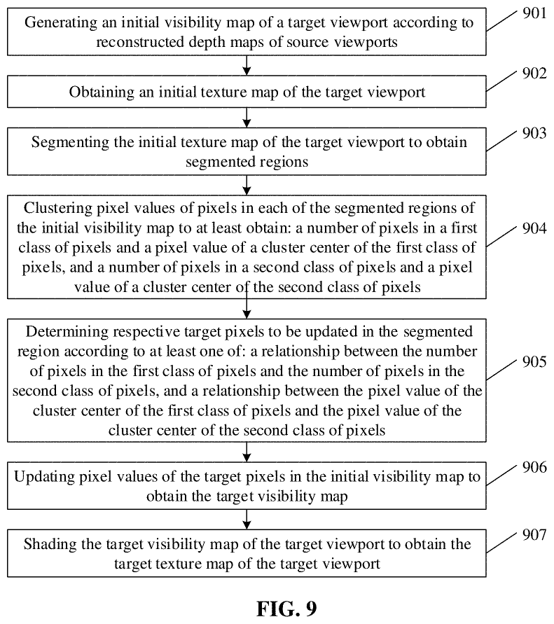

An embodiment of the present disclosure further provides a method of virtual viewport drawing. FIG. 9 is a flow diagram of an implementation of a method of virtual viewport drawing according to an embodiment of the present disclosure. As illustrated in FIG. 9, the method may include following operations 901 to 907.

At an operation 901, an initial visibility map of a target viewport is generated according to reconstructed depth maps of source viewports.

At an operation 902, an initial texture map of the target viewport is obtained.

At an operation 903, the initial texture map of the target viewport is segmented to obtain segmented regions.

At an operation 904, pixel values of pixels in each of the segmented regions of the initial visibility map are clustered to at least obtain: a number of pixels in a first class of pixels and a pixel value of a cluster center of the first class of pixels, and a number of pixels in a second class of pixels and a pixel value of a cluster center of the second class of pixels.

After performing the above operations, each segmented region has a respective cluster result. The clustering algorithm may be varied and are not limited in embodiments of the present disclosure. For example, the clustering algorithm may be the K-means clustering algorithm.

It can be understood that, the initial texture map can be segmented into several segmented regions through the operation 903. Regions corresponding to these segmented regions in the initial visibility map are taken as segmented regions of the initial visibility map. The electronic device can perform classification on pixels in part or all of the segmented regions in the initial visibility map. For example, in some embodiments, the electronic device may use a classification algorithm (e.g., a K-means clustering algorithm) to classify the pixels in each segmented region in the initial visibility map into two classes: non-target pixels belonging to background regions and target pixels belonging to noise regions (or transition zones).

At an operation 905, respective target pixels to be updated in the segmented region are determined according to at least one of: a relationship between the number of pixels in the first class of pixels and the number of pixels in the second class of pixels, and a relationship between the pixel value of the cluster center of the first class of pixels and the pixel value of the cluster center of the second class of pixels.

In some embodiments, in a case that a first operation result of subtracting the pixel value of the cluster center of the second class of pixels from the pixel value of the cluster center of the first class of pixels is greater than or equal to a first threshold value, and a second operation result of dividing the number of pixels in the first class of pixels by the number of pixels in the second class of pixels is greater than or equal to a second threshold value, it is determined that the second class of pixels are the target pixels to be updated in the segmented region, and accordingly, in this case, the first class of pixels are the non-target pixels.

In a case that a third operation result of subtracting the pixel value of the cluster center of the first class of pixels from the pixel value of the cluster center of the second class of pixels is greater than or equal to the first threshold value, and a fourth operation result of dividing the number of pixels in the second class of pixels by the number of pixels in the first class of pixels is greater than or equal to the second threshold value, it is determined that the first class of pixels are the target pixels to be updated in the segmented region, and accordingly, in this case, the second class of pixels are the non-target pixels.

In a case that the first operation result is less than the first threshold value or the second operation result is less than the second threshold value, and the third operation result is less than the first threshold value or the fourth operation result is less than the second threshold value, it is determined that both the first class of pixels and the second class of pixels are the non-target pixels in the segmented region.

At an operation 906: pixel values of the target pixels in the initial visibility map are updated to obtain the target visibility map.

The ways of updating can be varied. For example, the pixel values of the target pixels of the segmented region are replaced by a pixel value of a cluster center of the non-target pixels of the segmented region.

At an operation 907, the target visibility map of the target viewport is shaded to obtain the target texture map of the target viewport.

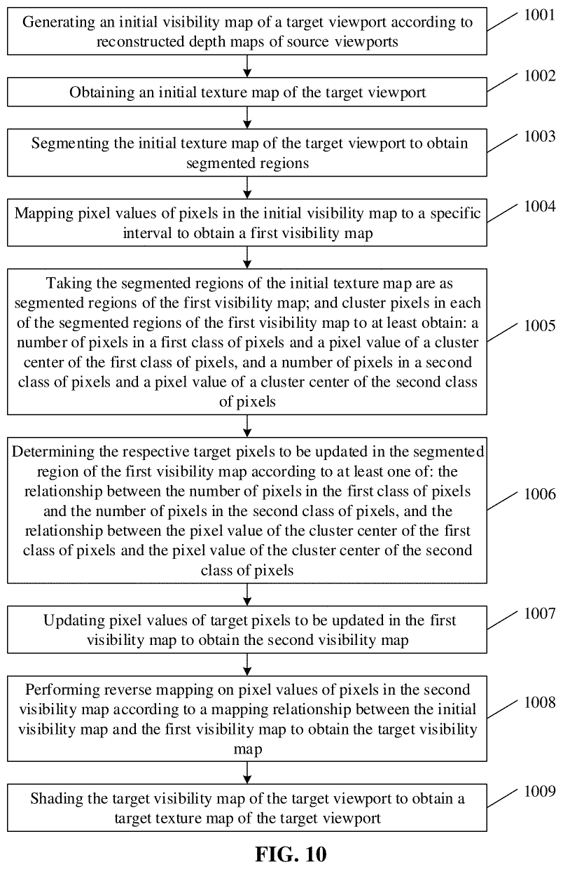

An embodiment of the present disclosure further provides a method of virtual viewport drawing. FIG. 10 is a flow diagram of an implementation of a method of virtual viewport drawing according to an embodiment of the present disclosure. As illustrated in FIG. 10, the method may include following operations 1001 to 1007.

At an operation 1001, an initial visibility map of a target viewport is generated according to reconstructed depth maps of source viewports.

At an operation 1002, an initial texture map of the target viewport is obtained.

At an operation 1003, the initial texture map of the target viewport is segmented to obtain segmented regions.

At an operation 1004, pixel values of pixels in the initial visibility map are mapped to a specific interval to obtain a first visibility map.

There are no limitations on the specific interval. For example, the specific interval can be [0, 255]. Of course, in practical application, engineers can also configure other specific intervals according to actual needs.

At an operation 1005, the segmented regions of the initial texture map are taken as segmented regions of the first visibility map; and pixels in each of the segmented regions of the first visibility map are clustered to at least obtain: the number of pixels in the first class of pixels and the pixel value of the cluster center of the first class of pixels, and the number of pixels in the second class of pixels and the pixel value of the cluster center of the second class of pixels.

At an operation 1006, the respective target pixels to be updated in the segmented region of the first visibility map are determined at least according to one of: the relationship between the number of pixels in the first class of pixels and the number of pixels in the second class of pixels, and the relationship between the pixel value of the cluster center of the first class of pixels and the pixel value of the cluster center of the second class of pixels.

In some embodiments, in a case that a first operation result of subtracting the pixel value of the cluster center of the second class of pixels from the pixel value of the cluster center of the first class of pixels is greater than or equal to a first threshold value, and a second operation result of dividing the number of pixels in the first class of pixels by the number of pixels in the second class of pixels is greater than or equal to a second threshold value, it is determined that the second class of pixels are the target pixels to be updated in the segmented region, and accordingly, in this case, the first class of pixels are the non-target pixels.

In a case that a third operation result of subtracting the pixel value of the cluster center of the first class of pixels from the pixel value of the cluster center of the second class of pixels is greater than or equal to the first threshold value, and a fourth operation result of dividing the number of pixels in the second class of pixels by the number of pixels in the first class of pixels is greater than or equal to the second threshold value, it is determined that the first class of pixels are the target pixels to be updated in the segmented region, and accordingly, in this case, the second class of pixels are the non-target pixels.

In a case that the first operation result is less than the first threshold value or the second operation result is less than the second threshold value, and the third operation result is less than the first threshold value or the fourth operation result is less than the second threshold value, it is determined that both the first class of pixels and the second class of pixels are the non-target pixels in the segmented region.

To put it simply, the cluster center of the first class of pixels is represented by cen₁, the cluster center of the second class of pixels is represented by cen₂, the number of pixels in the first class of pixels is represented by num₁, the number of pixels in the second class of pixels is represented by num₂, and the target pixels and the non-target pixels can be determined as follows.

a) If cen₁−cen₂≥the first threshold value and num₁/num₂≥the second threshold value, it is determined that the first class of pixels are the non-target pixels and the second class of pixels are the target pixels.

b) If cen₂−cen₁≥the first threshold value and num₂/num₁≥the second threshold value, it is determined that the first class of pixels are the target pixels and the second class of pixels are the non-target pixels.

c) Except for the above two cases a) and b), in other cases, it is determined that both the first class of pixels and the second class of pixels are the non-target pixels, and pixel values in the corresponding segmented region are not processed.

In some embodiments, a value range of the first threshold value is [25, 33] and a value range of the second threshold value is [5, 10]. For example, the first threshold value is 30 and the second threshold value is 7.

At an operation 1007, pixel values of target pixels to be updated in the first visibility map is updated to obtain a second visibility map.

In some embodiments, the operation of clustering the pixels in each of the segmented regions of the first visibility mapm further determines non-target pixels of the segmented region. The operation 1007 may be implemented as follows. A pixel replacement value of the segmented region is determined according to a pixel value of the non-target pixels of the segmented region of the first visibility map; and pixel values of the target pixels of the segmented region of the first visibility map are updated to the pixel replacement value of the segmented region, so as to obtain the second visibility map.

For example, a pixel value of a cluster center of the non-target pixels in the segmented region of the first visibility map is determined as the pixel replacement value of the segmented region.

At an operation 1008, according to a mapping relationship between the initial visibility map and the first visibility map, reverse mapping is performed on pixel values of pixels in the second visibility map to obtain the target visibility map.

It can be understood that, the quality improvement processing of the initial visibility map is implemented by the operations 1002 to 1008. That is to say, before determining the target pixels of the initial visibility map, pixel values of pixels in the initial visibility map are mapped to a specific interval, then the pixel values of the pixels in a mapping result (i.e., the first visibility map) are classified, and the pixel values of the target pixels determined by the classification are updated to obtain the second visibility map, and finally the second visibility map is reversely mapped as the target visibility map. In this way, the method of virtual viewport drawing has certain generalization ability, and thus is adaptable to the processing of various scene images.

At an operation 1009, the target visibility map of the target viewport is shaded to obtain a target texture map of the target viewport.

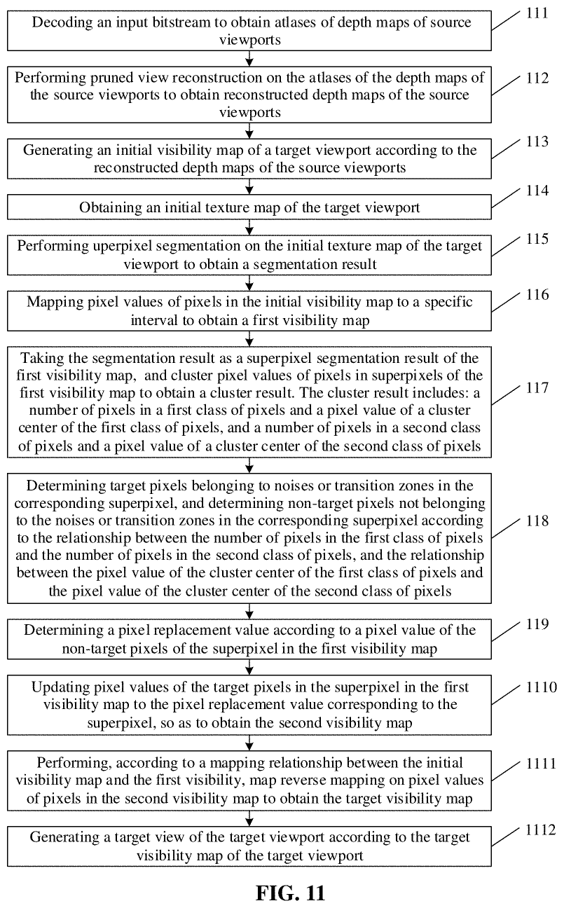

An embodiment of the present disclosure further provides a method of virtual viewport drawing. FIG. 11 is a flow diagram of an implementation of a method of virtual viewport drawing according to an embodiment of the present disclosure. As illustrated in FIG. 11, the method may include the following operations 111 to 1112.

At an operation 111, an input bitstream is decoded to obtain atlases of depth maps of source viewports.

At an operation 112, pruned view reconstruction is performed on the atlases of the depth maps of the source viewports to obtain reconstructed depth maps of the source viewports.

At an operation 113, an initial visibility map of a target viewport is generated according to the reconstructed depth maps of the source viewports.

At an operation 114, an initial texture map of the target viewport is obtained.

At an operation 115, superpixel segmentation is performed on the initial texture map of the target viewport to obtain a segmentation result.

At an operation 116, pixel values of pixels in the initial visibility map are mapped to a specific interval to obtain a first visibility map.

At an operation 117, the segmentation result are taken as a superpixel segmentation result of the first visibility map; and pixel values of pixels in superpixels of the first visibility map are clustered to obtain a cluster result. The cluster result includes: a number of pixels in a first class of pixels and a pixel value of a cluster center of the first class of pixels, and a number of pixels in a second class of pixels and a pixel value of a cluster center of the second class of pixels.

In some embodiments, the electronic device may employ a K-means clustering algorithm to classify pixel values of pixels in each of the superpixels in the first visibility map.

At an operation 118, according to the relationship between the number of pixels in the first class of pixels and the number of pixels in the second class of pixels, and the relationship between the pixel value of the cluster center of the first class of pixels and the pixel value of the cluster center of the second class of pixels, target pixels belonging to noises or transition zones in a corresponding superpixel are determined, and non-target pixels not belonging to the noises or transition zones in a corresponding superpixel are determined.

It can be understood that, each superpixel corresponds to a respective cluster result. Therefore, the corresponding superpixel herein refers to a superpixel corresponding to the respective cluster result, that is, the respective cluster result is a cluster result of the corresponding superpixel.

In some embodiments, in a case that a first operation result of subtracting the pixel value of the cluster center of the second class of pixels from the pixel value of the cluster center of the first class of pixels is greater than or equal to a first threshold value, and a second operation result of dividing the number of pixels in the first class of pixels by the number of pixels in the second class of pixels is greater than or equal to a second threshold value, it is determined that the second class of pixels are the target pixels to be updated in the corresponding superpixel, and accordingly, in this case, the first class of pixels are the non-target pixels.

In some embodiments, in a case that a third operation result of subtracting the pixel value of the cluster center of the first class of pixels from the pixel value of the cluster center of the second class of pixels is greater than or equal to the first threshold value, and a fourth operation result of dividing the number of pixels in the second class of pixels by the number of pixels in the first class of pixels is greater than or equal to the second threshold value, it is determined that the first class of pixels are the target pixels to be updated in the corresponding superpixel, and accordingly, in this case, the second class of pixels are the non-target pixels.

In some embodiments, in a case that the first operation result is less than the first threshold value or the second operation result is less than the second threshold value, and the third operation result is less than the first threshold value or the fourth operation result is less than the second threshold value, it is determined that both the first class of pixels and the second class of pixels are the non-target pixels in the segmented region.

In some embodiments, a value range of the first threshold value is [25, 33] and a value range of the second threshold value is [5, 10]. For example, the first threshold value is 30 and the second threshold value is 7.

At an operation 119, a pixel replacement value is determined according to a pixel value of the non-target pixels of the superpixel in the first visibility map.

In some embodiments, a mean value of the non-target pixels in the superpixel may be used as a pixel replacement value of the target pixels in the superpixel. For example, a pixel value of a cluster center of a class of the non-target pixels in the superpixel is taken as the pixel replacement value.

At an operation 1110, pixel values of the target pixels in the superpixel in the first visibility map are updated to the pixel replacement value corresponding to the superpixel, so as to obtain the second visibility map.

In some embodiments, a pixel value of a cluster center of the non-target pixels in the superpixel in the first visibility map is determined as the pixel replacement value.

In related technical solutions, filtering is often used to perform improve quality improvement processing on noises and transition zones in a visibility map, in order to disperse this influence. However, such technical solutions will change correct pixel values of pixels around the noises and transition zones (i.e., the non-target pixels), which makes the objective quality and subjective effect of a final target view slightly poor.

In an embodiment of present disclosure, the pixel values of these noises and transition zones (i.e., target pixels) are replaced with an approximately correct value (i.e., a pixel replacement value). Therefore, the pixel values of non-target pixels around the target pixels will not be changed. Compared with the filtering method, the method according to the embodiment of present disclosure can make the target pixels whose pixel values are replaced with surrounding regions more naturally, so that the objective quality and subjective effect of the final target view are better.

At an operation 1111, according to a mapping relationship between the initial visibility map and the first visibility map, reverse mapping is performed on pixel values of pixels in the second visibility map to obtain the target visibility map.

At an operation 1112, a target view of the target viewport is generated according to the target visibility map of the target viewport.

An embodiment of the present disclosure provides a rendering method, the rendering method can be applied not only to an electronic device, but also to a rendering device, and the method may include following operations. Pruned view reconstruction is performed on atlases of depth maps of source viewports to obtain reconstructed depth maps of the source viewports. Operations in a method of virtual viewport drawing according to an embodiment of the present disclosure are performed on the reconstructed depth maps of the source viewports to obtain a target texture map of a target viewport. A target view of the target viewport is generated according to the target texture map of the target viewport.

In some embodiments, an initial texture map of the target viewport is obtained through following operations. Pruned view reconstruction is performed on atlases of texture maps of the source viewports to obtain reconstructed texture maps of the source viewports. The initial texture map of the target viewport is obtained by shading an initial visibility map of the target viewport according to the reconstructed texture maps of the source viewports.

In some embodiments, the atlas of the texture maps of the source viewports are obtained through decoding an bitstream by an electronic device.

In some embodiments, the operation 113 is implemented as follows. A target visibility map of the target viewport is shaded to obtain a target texture map of the target viewport. Hole inpainting is performed on the target texture map to obtain an initial view. View space processing is performed on the initial view to obtain the target view.

The description of the rendering method embodiment is similar to the description of the other method embodiments described above and has similar beneficial effects as the other method embodiments described above. Technical details not disclosed in the rendering method embodiment are understood with reference to the above description of other method embodiments.

An embodiment of the present disclosure provides a decoding method, which includes following operations. An input bitstream is decoded to obtain atlases of depth maps of source viewports. Pruned view reconstruction is performed on the atlases of the depth maps of the source viewports to obtain reconstructed depth maps of the source viewports. The operations in the method of virtual viewport drawing according to the embodiment of the present disclosure is performed on the reconstructed depth maps of the source viewports to obtain a target texture map of a target viewport. A target view of the target viewport is generated according to the target texture map of the target viewport.

In some embodiments, the bitstream is decoded to further obtain atlases of texture maps of the source viewports. An initial texture map of the target viewport is obtained through following operations. Pruned view reconstruction is performed on atlases of texture maps of the source viewports to obtain reconstructed texture maps of the source viewports; the initial texture map of the target viewport is obtained by shading an initial visibility map of the target viewport according to the reconstructed texture maps of the source viewports.

It should be noted that, the number of source viewports based on which atlases of the depth maps and atlases of texture maps of are obtained is not limited. An electronic device obtains, through decoding, the atlases of the depth maps and the atlases of the texture maps of one or at least one source viewport.

In the embodiment of the present disclosure, after obtaining atlases of depth maps of source viewports by decoding the received bitstream, pruned view reconstruction is performed on the atlases of the depth maps of the source viewports to obtain reconstructed depth maps of the source viewports; and an initial visibility map of the target viewport is generated according to the reconstructed depth maps of the source viewports. At this time, instead of directly generating the initial visibility map of the target viewport into a target view of the target viewport, quality improvement processing is performed on the initial visibility map at first, and the target view is generated based on a target visibility map obtained by performing the quality improvement processing on the initial visibility map. In this way, on the one hand, noises and/or transition zones in the finally obtained target view are obviously reduced. On the other hand, on the basis of ensuring the image quality of the target view, an encoding end can use a quantization parameter with a larger value to compress and encode the depth maps, and thus reducing the coding overhead of the depth maps and improving the overall coding efficiency.

The above description of the decoding method embodiment is similar to the description of the other method embodiments described above and has similar beneficial effects as the other method embodiments described above. Technical details not disclosed in the embodiment of the decoding method are understood with reference to the above description of other method embodiments.

Exemplary application of embodiments of the present disclosure in a practical application scenario will be described below.

In the embodiment of the present disclosure, a technical solution for optimizing depth maps in viewport generation by adopting the superpixel segmentation. The technical solution is an improvement on the basis of the VWS. The technical solution aims at optimizing visibility maps under a target viewport obtained in a visibility map generation operation of the VWS. The visibility map and the depth map have the same meaning, which both represent a distance relationship between a scene and a camera position. The visibility map is different from the depth map in that the closer to the camera position in the visibility map, the smaller the pixel value.

In the embodiment of the present disclosure, a superpixel segmentation algorithm is adopted to segment an initial texture map generated by the VWS, and the segmentation result is applied to an initial visibility map generated by the VWS. K-means clustering is used to cluster superpixels on the initial visibility map, so as to separate noises to be processed, transition zones to be processed and regions not to be processed, and then replace pixel values of the noises to be processed and the transition zones to be processed.

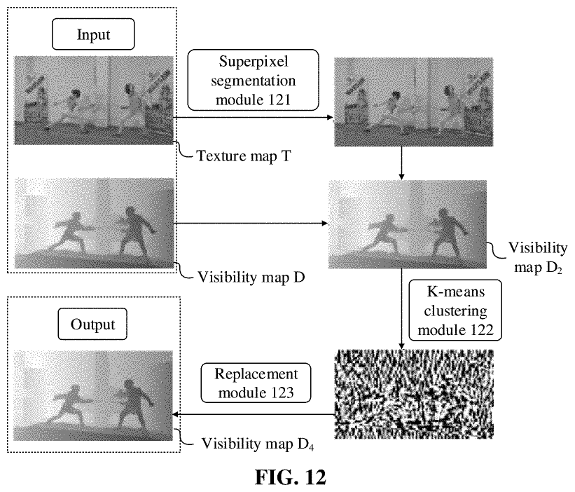

As illustrated in FIG. 12, the technical solution of the embodiment of the present disclosure is divided into three modules: a superpixel segmentation module 121, a K-means clustering module 122 and a replacement module 123.

At first, a generated visibility map D (i.e., the initial visibility map) is obtained through a visibility map generation operation of the VWS. Due to test sequences of different scene contents, a value range of pixel values in the initial visibility map is different. In the embodiment of the present disclosure, the pixel values in the visibility map D can be transformed into a interval of [0,255] by using a linear mapping algorithm to obtain a visibility map D₂ (i.e., the first visibility map). Then, a generated texture map T (i.e., the initial texture map) is obtained from the shading operation, and the texture map T is segmented by using an SLIC superpixel segmentation algorithm with a number of superpixels (numSuperpixel) being 1200. Then, the superpixel segmentation result obtained from the texture map T is applied to the visibility map D₂, and several superpixels Sᵢ divided on the visibility map D₂ are obtained. A K-means clustering algorithm is used to divide pixels in each superpixel Sᵢ into two classes: C₁ and C₂. A cluster center of C₁ is cen₁ and a cluster center of C₂ is cen₂. The number of pixels of the class C₁ is num₁ and the number of pixels of the class C₂ is num₂. Comparing the cluster centers cen₁ and cen₂, and the number of pixels num₁ and num₂, the visibility map D₂ is processed by the following procedure.

a) If cen₁−cen₁>30 and num₁/num₂>7, it is determined that C₁ is a background region and C₂ is a noise region or a transition zone, then all pixels in C₁ are not processed, which means that original values of all pixels in C₁ are kept unchanged, and values of all pixels in C₂ are replaced by cen₁. The value 30 is an example of the first threshold value and the value 7 is an example of the second threshold value.

b) If cen₂−cen₁>30 and num₂/num₁>7, it is determined that C₂ is a background region and C₁ is a noise region or a transition zone, then all pixels in C₂ are not processed, which means that original values of all pixels in C₂ are kept unchanged, and values of all pixels in C₁ are replaced by cen₂.

c) Except for the above two cases, all pixels in C₁ and C₂ are not processed in other cases, which means that original values of all pixels in C₁ and C₂ are kept unchanged.

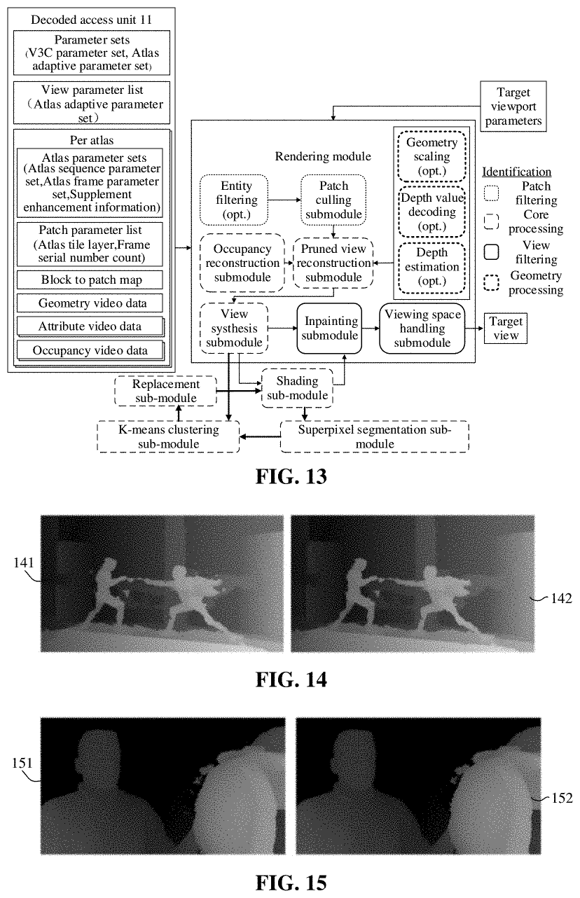

After the above processing, an optimized visibility map D₃ (i.e., the second visibility map) is obtained. The visibility map D₃ is reversely linearly mapped and scaled to the original value range to obtain a visibility map D₄ (that is, the target visibility map). The visibility map D₄ is used to replace the original visibility map D, and the shading operation is performed on the visibility map D₄ again to obtain an optimized texture map T2 (i.e., the target texture map). System architecture after introducing depth map optimization technique is illustrated in FIG. 13.

The technical solution provided by embodiments of the present disclosure can be implemented on TMIV6.0, and the test sequence of natural scene content is tested in a common test condition. The experimental result shows that noises in the depth map of the generated target view are greatly reduced after the introduction of this technical solution in the VWS, and some junctions between foreground and background in the texture map become clearer and distinct. Because the superpixel segmentation algorithm adopts the SLIC superpixel segmentation algorithm, the technical solution improves the quality of depth map and the texture map of the target viewport to a certain extent without significantly increasing the rendering time.

The experimental configuration in some embodiments is as follows. The SLIC algorithm is adopted for the superpixel segmentation. The number of superpixels (numSuperpixel) is 1200. In K-means clustering algorithm, the value of K is 2. A threshold value of the difference between cluster centers cen₁ and cen₂ is selected as 30. A threshold value of the ratio of the number of pixels num₁ and num₂ of the two clusters is selected as 7.

Considering from the perspective of possible implementations related to the solution, one or more of the above configuration parameters may not be a fixed value. Related implementations may include: (1) encoding, in the bitstream, the above one or more parameter values needed to be used in the execution process of the method of the embodiment of the present disclosure, and data units used in the bitstream include: a sequence layer data unit (such as a Sequence Parameter Set (SPS), a Picture Parameter Set (PPS)), an image layer data unit (such as, PPS, an Adaptation Parameter Set (APS), a picture header, a slice header, etc.), a block layer data unit (such as a Coding Tree Unit (CTU), a Coding Unit (CU) layer data unit); (2) using implicit derivation method to determine the above one or more parameter values; (3) an adaptive determination method of sequence, image and block layer of the above parameter values in conjunction with (1) and (2).

For example, based on the above experimental configuration, the contrast effect of depth maps before and after using the technical solution provided by the embodiment of the present disclosure is illustrated in FIG. 14. A depth map 141 on the left is a depth map generated by using a test sequence of a Fencing scene before using the technical solution provided by the embodiment of the present disclosure, and a depth map 142 on the right is a depth map generated by using a Fencing test sequence after using the technical solution provided by the embodiment of the present disclosure. It can be seen from the FIG. 14 that, compared with the depth map 141 on the left, noises in the depth map 142 on the right are significantly reduced, especially in an area in a rectangular frame where noises are eliminated. Moreover, after replacing noises with pixel values of cluster centers, the noises are integrated with surrounding regions, and the image effect is naturally clear.

For another example, based on the above experimental configuration, the contrast effect of depth maps before and after using the technical solution provided by the embodiment of the present disclosure is illustrated in FIG. 15. A depth map 151 on the left is a depth map generated by using a test sequence of a Frog scene before using the technical solution provided by the embodiment of the present disclosure, and a depth map 152 on the right is a depth map generated by using a Frog test sequence after using the technical solution provided by the embodiment of the present disclosure. It can be seen from the FIG. 15 that, compared with the depth map 151 on the left, noises in the depth map 152 on the right are significantly reduced, especially in an area in a rectangular frame where noises are eliminated. Moreover, after replacing noises with pixel values of cluster centers, the noises are integrated with surrounding regions, and the image effect is naturally clear.

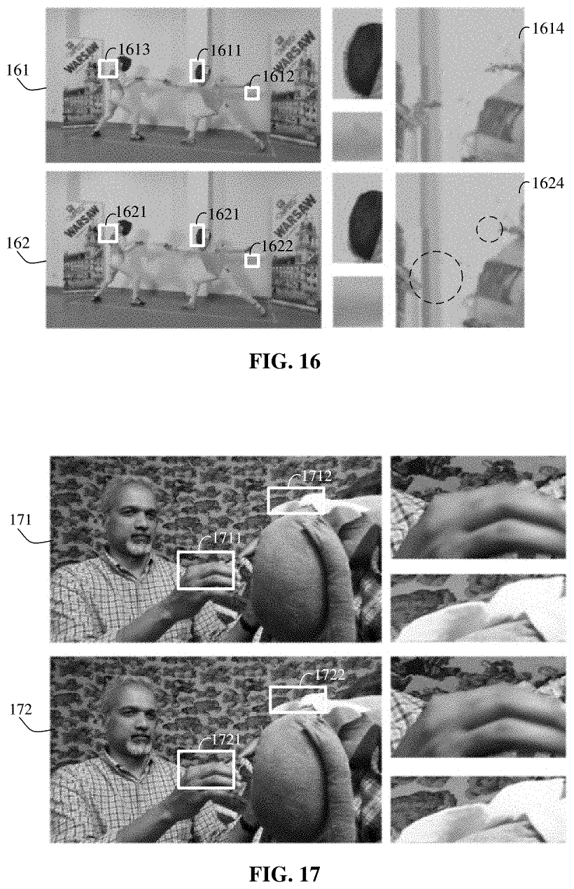

For another example, based on the above experimental configuration, the contrast effect of texture maps before and after using the technical solution provided by the embodiment of the present disclosure is illustrated in FIG. 16. A texture map 161 located above is a texture map generated by using the Fencing test sequence before using the technical solution provided by the embodiment of the present disclosure, and a texture map 162 located below is a texture map generated by using the Fencing test sequence after using the technical solution provided by the embodiment of the present disclosure. As can be seen from the FIG. 16, the texture map 162 located below has better image quality. For example, an edge region in a rectangular frame 1611 in the texture map 161 located above has an obvious transition zone, while a transition zone in an edge region in a rectangular frame 1621 in the lower texture map 162 is obviously sharpened. For another example, a noisy block similar to a triangle obviously exists in a rectangular frame 1612 in the texture map 161 located above, while a noisy block in a rectangular frame 1622 in the texture map 162 located below disappears. For still another example, there are obviously many noises in a rectangular frame 1613 in the texture map 161 located above. After enlargement, there are obvious noises in a circular frame region 1614, while most of the noises in a rectangular frame 1621 in the texture map 162 located below disappear. After enlargement, most of the noises in a circular frame region in 1624 disappear, and edge regions are obviously sharpened. Moreover, it can be seen from the FIG. 16 that, after replacing noises with pixel values of cluster centers, the noises are integrated with surrounding regions, and the image effect is naturally clear.

For another example, based on the above experimental configuration, the contrast effect of texture maps before and after using the technical solution provided by the embodiment of the present disclosure is illustrated in FIG. 17. A texture map 171 located above is a texture map generated by using the Frog test sequence before using the technical solution provided by the embodiment of the present disclosure, and a texture map 172 located below is a texture map generated by using the Frog test sequence after using the technical solution provided by the embodiment of the present disclosure. As can be seen from the FIG. 17, the texture map 172 located below has better image quality. For example, edge regions of a human hand in a rectangular frame 1711 in the texture map 171 located above have obvious transition zones, while transition zones of edge regions of a human hand in a rectangular frame 1721 in the texture map 172 located below are obviously sharpened. For another example, edge regions of a doll's collar in a rectangular frame 1712 in the texture map 171 located above have obvious transition zones, while transition zones of edges of the doll's collar in a rectangular frame 1722 in the texture map 172 located below disappear. Moreover, it can be seen from the FIG. 17 that, after replacing transition zones with pixel values of cluster centers, transition zones are integrated with surrounding regions, and the image effect is naturally clear.

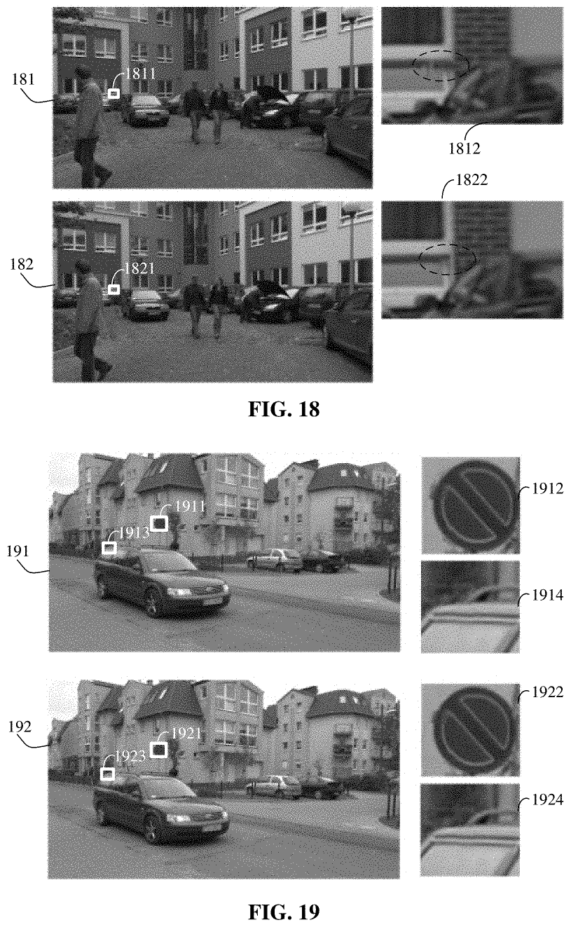

For another example, based on the above experimental configuration, the contrast effect of texture maps before and after using the technical solution provided by the embodiment of the present disclosure is illustrated in FIG. 18. A texture map 181 located above is a texture map generated by using a test sequence of a Carpark scene before using the technical solution provided by the embodiment of the present disclosure, and a texture map 182 located below is a texture map generated by using a Carpark test sequence after using the technical solution provided by the embodiment of the present disclosure. As can be seen from the FIG. 18, the texture map 182 located below has better image quality. For example, a region in a rectangular frame 1811 in the texture map 181 located above is enlarged as illustrated in 1812, in which there are obvious noises in a circular frame, while a region in a rectangular frame 1821 in the texture map 182 located below is enlarged as illustrated in 1822, in which most of the noises disappear in a circular frame, especially window edges are clearer. Moreover, it can be seen from the FIG. 18 that, after replacing noises with pixel values of cluster centers, the noises are integrated with surrounding regions, and the image effect is naturally clear.

For another example, based on the above experimental configuration, the contrast effect of texture maps before and after using the technical solution provided by the embodiment of the present disclosure is illustrated in FIG. 19. A texture map 191 located above is a texture map generated by using a test sequence of a Street scene before using the technical solution provided by the embodiment of the present disclosure, and a texture map 192 located below is a texture map generated by using a Street test sequence after using the technical solution provided by the embodiment of the present disclosure. As can be seen from the FIG. 19, the texture map 192 located below has better image quality. For example, a region in a rectangular frame 1911 in the texture map 191 located above is enlarged as illustrated in 1912, in which there are obvious transition zones on upper left edges of a sign, while a region in a rectangular frame 1921 in the texture map 192 located below is enlarged as illustrated in 1922, in which transition zones on the upper left edges of the sign basically disappears. For another example, a region in a rectangular frame 1913 in the texture map 191 located above is enlarged as illustrated in 1914, in which there are transition zones at edges of an arc-shaped rod bracket above a car, while a region in a rectangular frame 1923 in the texture map 192 located below is enlarged as illustrated in 1924, in which edges of the arc-shaped rod bracket above the car becomes clear. Moreover, it can be seen from the FIG. 19 that, after replacing transition zones with pixel values of cluster centers, the transition zones are integrated with surrounding regions, and the image effect is naturally clear.

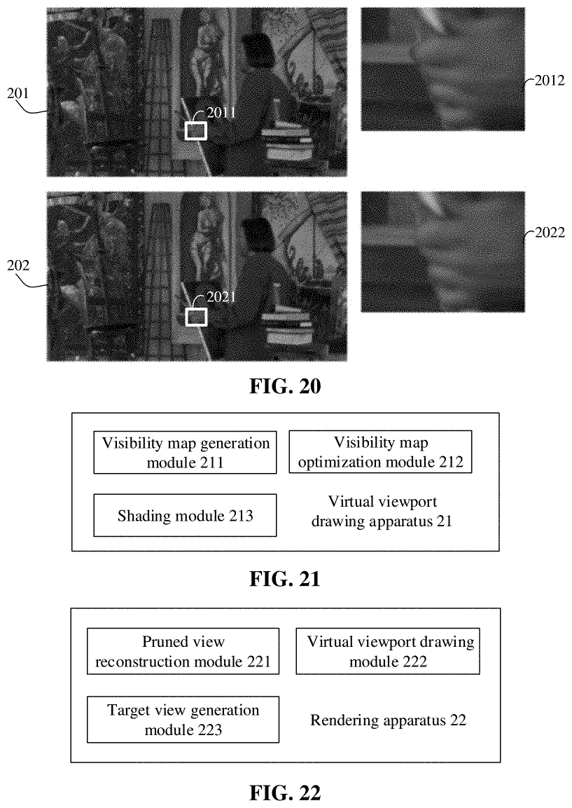

For another example, based on the above experimental configuration, the contrast effect of texture maps before and after using the technical solution provided by the embodiment of the present disclosure is illustrated in FIG. 20. A texture map 201 located above is a texture map generated by using a test sequence of a Painter scene before using the technical solution provided by the embodiment of the present disclosure, and a texture map 202 located below is a texture map generated by using a Painter test sequence after using the technical solution provided by the embodiment of the present disclosure. As can be seen from the FIG. 20, the texture map 202 located below has better image quality. For example, a region in a rectangular frame 2011 in the texture map 201 located above is enlarged as illustrated in 2012, in which there are obvious transition zones on edges of a human hand, while a region in a rectangular frame 2021 in the texture 202 located below is enlarged as illustrated in 2022, in which transition zones on the edges of the human hand basically disappears, especially edges of the index finger and the middle finger are clearer. Moreover, it can be seen from the FIG. 20 that, after replacing transition zones with pixel values of cluster centers, the transition zones are integrated with surrounding regions, and the image effect is naturally clear.

From the experimental results illustrated in FIG. 14 to FIG. 20, it can be seen that, compared with views generated by the VWS, the technical solution provided by the embodiment of the present disclosure effectively restrains the adverse influence caused by the compression distortion of the depth map on the generated view. Therefore, compared with the VWS, the technical solution provided by the embodiment of the present disclosure can adopt a QP with a larger value to compress the depth map under the condition of ensuring the quality of the finally obtained texture map, thereby reducing the coding overhead of the depth map and further improving the overall coding efficiency.

In the embodiment of the present disclosure, a Simple Linear Iterative Cluster (SLIC) superpixel segmentation algorithm and a K-means clustering algorithm are adopted to separate noises and transition zones in the visibility map, and the noises and the transition zones in the visibility map are processed, thereby improving the objective quality and subjective effect of the depth map and the texture map.

Based on the aforementioned embodiments, the apparatus of virtual viewport drawing provided by the embodiment of the present disclosure includes each module and each unit included in each module, which can be implemented by a decoder or a processor in an electronic device. Of course, the apparatus can also be implemented by specific logic circuits. In the implementation process, the processor can be a central processing unit (CPU), a microprocessor (MPU), a digital signal processor (DSP), a field programmable gate array (FPGA) or a Graphics Processing Unit (GPU), etc.

FIG. 21 is a structural diagram of an apparatus of virtual viewport drawing according to an embodiment of the present disclosure. As illustrated in FIG. 21, an apparatus 21 includes a visibility map generation module 211, a visibility map optimization module 212 and a shading module 213.

The visibility map generation module 211 is configured to generate an initial visibility map of a target viewport according to reconstructed depth maps of source viewports.

The visibility map optimization module 212 is configured to perform quality improvement processing on the initial visibility map to obtain a target visibility map of the target viewport.

The shading module 213 is configured to shade the target visibility map of the target viewport to obtain a target texture map of the target viewport.

In some embodiments, the visibility map optimization module 212 is configured to perform at least one of the noise elimination processing or the edge enhancement processing on regions corresponding to the segmented regions on the initial visibility map to obtain the target visibility map of the target viewport.

In some embodiments the visibility map optimization module 212 includes an obtaining unit, a segmentation unit and an enhancement unit. The obtaining unit is configured to obtain an initial texture map of the target viewport. The segmentation unit is configured to segment the initial texture map of the target viewport to obtain segmented regions. The enhancement unit is configured to perform at least one of the noise elimination processing or the edge enhancement processing on regions corresponding to the segmented regions on the initial visibility map to obtain the target visibility map of the target viewport.

In some embodiments, the segmentation unit is configured to perform superpixel segmentation on the initial texture map of the target viewport by using an SLIC superpixel segmentation algorithm, and the segmented regions are superpixels.

In some embodiments, the enhancement unit includes: a classification subunit and an updating subunit. The classification subunit is configured to take the segmented regions of the initial texture map as segmented regions of the initial visibility map and classify pixels in the segmented regions of the initial texture map to determine target pixels to be updated in the segmented regions of the initial visibility map. The updating subunit is configured to update pixel values of the target pixels in the initial visibility map to obtain the target visibility map.

In some embodiments, the classifying sub-unit is configured to: cluster pixel values of pixels in each of the segmented regions of the initial visibility map to at least obtain: a number of pixels in a first class of pixels and a pixel value of a cluster center of the first class of pixels, and a number of pixels in a second class of pixels and a pixel value of a cluster center of the second class of pixels; and determine respective target pixels to be updated in the segmented region according to at least one of: a relationship between the number of pixels in the first class of pixels and the number of pixels in the second class of pixels, and a relationship between the pixel value of the cluster center of the first class of pixels and the pixel value of the cluster center of the second class of pixels.

In some embodiments, the classification subunit is configured to: map pixel values of pixels in the initial visibility map to a specific interval to obtain a first visibility map; take the segmented regions of the initial texture map as segmented regions of the first visibility map; and cluster pixels in each of the segmented regions of the first visibility map to at least obtain: the number of pixels in the first class of pixels and the pixel value of the cluster center of the first class of pixels, and the number of pixels in the second class of pixels and the pixel value of the cluster center of the second class of pixels; and determine the respective target pixels to be updated in the segmented region of the first visibility map according to at least one of: the relationship between the number of pixels in the first class of pixels and the number of pixels in the second class of pixels, and the relationship between the pixel value of the cluster center of the first class of pixels and the pixel value of the cluster center of the second class of pixels. Accordingly, the updating subunit is configured to: update pixel values of target pixels to be updated in the first visibility map to obtain a second visibility map; and perform, according to a mapping relationship between the initial visibility map and the first visibility map, reverse mapping on pixel values of pixels in the second visibility map to obtain the target visibility map.

In some embodiments, the classification subunit is further configured to: cluster pixels in each of the segmented regions of the first visibility map to determine respective non-target pixels in the segmented region. Accordingly, the updating subunit is configured to: determine a pixel replacement value of the segmented region according to a pixel value of the non-target pixels of the segmented region of the first visibility map; update pixel values of the target pixels of the segmented region of the first visibility map to the pixel replacement value of the segmented region, so as to obtain a second visibility map.

In some embodiments, the update subunit is configured to determine a pixel value of a cluster center of the non-target pixels in the segmented region of the first visibility map as the pixel replacement value of the segmented region.

In some embodiments, the classification subunit is configured to determine that the second class of pixels are the target pixels to be updated in the segmented region, in a case that a first operation result of subtracting the pixel value of the cluster center of the second class of pixels from the pixel value of the cluster center of the first class of pixels is greater than or equal to a first threshold value, and a second operation result of dividing the number of pixels in the first class of pixels by the number of pixels in the second class of pixels is greater than or equal to a second threshold value; and determine that the first class of pixels are the target pixels to be updated in the segmented region, in a case that a third operation result of subtracting the pixel value of the cluster center of the first class of pixels from the pixel value of the cluster center of the second class of pixels is greater than or equal to the first threshold value, and a fourth operation result of dividing the number of pixels in the second class of pixels by the number of pixels in the first class of pixels is greater than or equal to the second threshold value.

In some embodiments, the classification subunit is configured to determine that both the first class of pixels and the second class of pixels are the non-target pixels in the segmented region, in a case that the first operation result is less than the first threshold value or the second operation result is less than the second threshold value, and the third operation result is less than the first threshold value or the fourth operation result is less than the second threshold value.

In some embodiments, a value range of the first threshold value is [25, 33] and a value range of the second threshold value is [5, 10].

In some embodiments, the first threshold value is 30 and the second threshold value is 7.

The description of the above apparatus embodiment is similar to the description of the above method embodiment and the above apparatus embodiment has the same beneficial effect as the method embodiment. Technical details not disclosed in the apparatus embodiment of the present disclosure are understood with reference to the description of the method embodiment of the present disclosure.

An embodiment of the present disclosure provides a rendering apparatus. FIG. 22 is a structural diagram of a rendering apparatus according an embodiment of the present disclosure. As illustrated in FIG. 22, an apparatus 22 includes a pruned view reconstruction module 221, a virtual viewport drawing module 222 and a target view generation module 223.

The pruned view reconstruction module 221 is configured to perform pruned view reconstruction on atlases of depth maps of source viewports to obtain reconstructed depth maps of the source viewports.

The virtual viewport drawing module 222 is configured to perform operations in the method of virtual viewport drawing described in the embodiment of the present disclosure on the reconstructed depth maps of the source viewports to obtain a target texture map of a target viewport.

The target view generation module 223 is configured to generate a target view of the target viewport according to the target texture map of the target viewport.

The description of the above apparatus embodiment is similar to the description of the above method embodiment and the above apparatus embodiment has the same beneficial effect as the method embodiment. Technical details not disclosed in the apparatus embodiment of the present disclosure are understood with reference to the description of the method embodiment of the present disclosure.

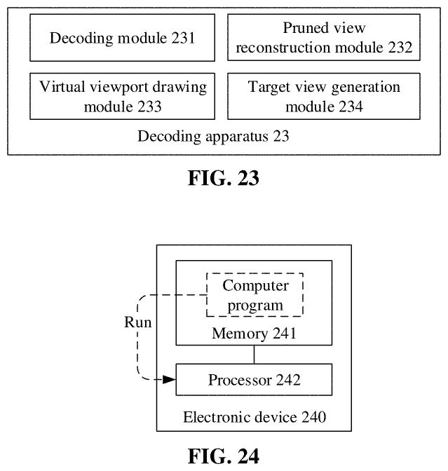

An embodiment of the present disclosure provides a decoding apparatus. FIG. 23 is a structural diagram of a decoding apparatus according to an embodiment of the present disclosure. As illustrated in FIG. 23, an apparatus 23 includes a decoding module 231, a pruned view reconstruction module 232, a virtual viewport drawing module 233 and a target view generation module 234.

The decoding module 231 is configured to decode an input bitstream to obtain atlases of depth maps of source viewports.

The pruned view reconstruction module 232 is configured to perform pruned view reconstruction on the atlases of the depth maps of the source viewports to obtain reconstructed depth maps of the source viewports.

The virtual viewport drawing module 233 is configured to perform operations in the method of virtual viewport drawing according to an embodiment of the present disclosure on the reconstructed depth map of the source viewports to obtain a target texture map of a target viewport.

The target view generation module 234 is configured to generate a target view of the target viewport according to the target texture map of the target viewport.

The description of the above apparatus embodiment is similar to the description of the above method embodiment and the above apparatus embodiment has the same beneficial effect as the method embodiment. Technical details not disclosed in the apparatus embodiment of the present disclosure are understood with reference to the description of the method embodiment of the present disclosure.

It should be noted that, in the embodiment of the present disclosure, if the method of virtual viewport drawing is implemented in the form of a software function module and sold or used as an independent product, it can also be stored in a computer-readable storage medium. Based on this understanding, the technical solution of the embodiments of the present disclosure may be embodied in the form of a software product in essence or contributing to the related technology. The computer software product is stored in a storage medium and includes instructions for causing the electronic device to perform all or part of the methods described in the various embodiments of the present disclosure. The aforementioned storage media includes various media capable of storing program codes, such as U disk, mobile hard disk, Read Only Memory (ROM), magnetic disk or optical disk. Thus embodiments of the present disclosure are not limited to any particular combination of hardware and software.

Correspondingly, an embodiment of the present disclosure provides an electronic device. FIG. 24 is a diagram of hardware entities of an electronic device according to an embodiment of the present disclosure. As illustrated in FIG. 24, an electronic device 240 includes a memory 241 and a processor 242. The memory 241 is configured to store a computer program executable on the processor 242. The processor 242 implements operations in the method provided in the above embodiments when executing the computer program.

It should be noted that, the memory 241 is configured to store instructions and applications executable by the processor 242, and is further configured to cache data (e.g., image data, audio data, voice communication data and video communication data) to be processed or data that has been already processed by the processor 242 and various modules in the electronic device 240, which may be implemented by a FLASH memory (FLASH) or a Random Access Memory (RAM).

Correspondingly, an embodiment of the present disclosure provides a computer-readable storage medium on which a computer program is stored, and the computer program, when executed by a processor, implements the method of virtual viewport drawing provided in the above embodiment.

An embodiment of the present disclosure provides a decoder, which is configured to implement the decoding method of the embodiment of the present disclosure.

An embodiment of the present disclosure provides a rendering device, which is configured to implement the rendering method of the embodiment of the present disclosure.

An embodiment of the present disclosure provides a view weighting synthesizer, which is configured to implement methods of the embodiments of the present disclosure.

It should be noted here that the above descriptions of the embodiments of the electronic device, the storage medium, the decoder, the rendering device and the view weighting synthesizer are similar to those of the above method embodiments and the embodiments of the electronic device, the storage medium, the decoder, the rendering device and the view weighting synthesizer have similar beneficial effects as those of the method embodiments. Technical details not disclosed in the embodiments of the electronic device, the storage medium, the decoder, the rendering device and the view weighting synthesizer of the present disclosure may be understood with reference to the description of method embodiments of the present disclosure.

It should be understood that, references to “one embodiment” or “an embodiment” mentioned throughout the specification means that specified features, structures, or characteristics related to the embodiment are included in at least one embodiment of the present disclosure. Therefore, “in one embodiment” or “in an embodiment” appearing throughout the specification does not necessarily refer to a same embodiment. In addition, these specified features, structures, or characteristics may be combined in one or more embodiments in any appropriate manner. It should be understood that, in the embodiments of the present disclosure, sequence numbers of the foregoing processes do not mean execution sequences. The execution sequences of the processes should be determined according to functions and internal logic of the processes, and should not be construed as any limitation on the implementation processes of the embodiments of the present disclosure. The sequence numbers of the embodiments of the above-mentioned application are merely for the description, and do not represent the advantages and disadvantages of the embodiments.

It should be noted that, in this article, terms “include” and “contain” or any other variants thereof are intended to cover nonexclusive inclusions, so that, a process, a method, an item or an apparatus including a series of elements not only includes those elements but also includes other elements which are not clearly listed or further includes intrinsic elements of the process, the method, the item or the device. Under the condition of no more limitations, an element defined by a statement “including a/an” does not exclude existence of additional same elements in the process, the method, the item or the device.

In several embodiments provided by the present disclosure, it is to be understood that, the disclosed device and method may be implemented in other manners. The apparatus embodiment described above is only schematic, and for example, division of the modules is only logic function division, and other division manners may be adopted during practical implementation. For example, a plurality of modules or components may be combined or integrated into another system, or some characteristics may be neglected or not executed. In addition, coupling or direct coupling or communication connection between each displayed or discussed component may be indirect coupling or communication connection, implemented through some interfaces, of the device or the modules, and may be electrical and mechanical or adopt other forms.

The above-mentioned modules described as separate parts may be or may not be physically separate, and the parts illustrated as modules may be or may not be physical elements, which may be located in one place or distributed to a plurality of network elements. Part or all of the modules may be selected to achieve the objectives of the solutions of the embodiments according to practical requirements.

In addition, each function module in each embodiment of the present disclosure may be integrated into a processing unit, each module may also serve as an independent unit and two or more than two modules may also be integrated into a unit. The integrated module may be implemented in a hardware form and may also be implemented in form of hardware and software function unit.

Those of ordinary skill in the art will appreciate that: all or part of the steps of the above-mentioned method embodiments may be completed through hardware associated with program instructions. The foregoing program may be stored in a computer readable storage medium. The steps including the above-mentioned method embodiments are executed when the program is executed. The foregoing storage medium includes various media capable of storing program codes, such as a mobile storage device, a Read Only Memory (ROM), a magnetic disc or a compact disc.

Alternatively, when implemented in form of software function module and sold or used as an independent product, the integrated unit of the present disclosure may also be stored in a computer readable storage medium. Based on such an understanding, the technical solutions of the embodiments of the present disclosure substantially or parts making contributions to the related art may be embodied in a form of a software product. The computer software product is stored in a storage medium, including a plurality of instructions configured to enable an electronic device (which may be a personal computer, a server, a network device, or the like) to execute all or part of the method in each embodiment of the present disclosure. The foregoing storage medium includes: various media capable of storing program codes, such as a mobile storage device, the ROM, a magnetic disc, or a compact disc.

The methods disclosed in several method embodiments provided in the present disclosure may be arbitrarily combined without conflict to obtain new method embodiments. The features disclosed in several product embodiments provided in the present disclosure may be arbitrarily combined without conflict to obtain new product embodiments. The features disclosed in several method embodiments or device embodiments provided in the present disclosure may be arbitrarily combined without conflict to obtain new method embodiments or new device embodiments.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the scope of protection of the present disclosure shall be subject to the scope of protection of the claims.

1. A method of virtual viewport drawing, comprising:
generating an initial visibility map of a target viewport according to reconstructed depth maps of source viewports;
performing quality improvement processing on the initial visibility map to obtain a target visibility map of the target viewport; and
shading the target visibility map of the target viewport to obtain a target texture map of the target viewport.

2. The method of claim 1, wherein performing the quality improvement processing on the initial visibility map to obtain the target visibility map of the target viewport comprises:
performing at least one of noise elimination processing or edge enhancement processing on the initial visibility map to obtain the target visibility map of the target viewport.

3. The method of claim 2, wherein performing at least one of the noise elimination processing or the edge enhancement processing on the initial visibility map to obtain the target visibility map of the target viewport comprises:
obtaining an initial texture map of the target viewport;
segmenting the initial texture map of the target viewport to obtain segmented regions; and
performing at least one of the noise elimination processing or the edge enhancement processing on regions corresponding to the segmented regions on the initial visibility map to obtain the target visibility map of the target viewport.

4. The method of claim 3, wherein segmenting the initial texture map of the target viewport to obtain the segmented regions comprises:
performing, by using a simple linear iterative cluster (SLIC) superpixel segmentation algorithm, superpixel segmentation on the initial texture map of the target viewport, the segmented regions being superpixels.

5. The method of claim 3, wherein performing at least one of the noise elimination processing or the edge enhancement processing on the regions corresponding to the segmented regions on the initial visibility map to obtain the target visibility map of the target viewport comprises:
taking the segmented regions of the initial texture map as segmented regions of the initial visibility map, classifying pixels in the segmented regions of the initial visibility map to determine target pixels to be updated in the segmented regions of the initial visibility map; and
updating pixel values of the target pixels to be updated in the initial visibility map to obtain the target visibility map.

6. The method of claim 5, wherein classifying the pixels in the segmented regions of the initial visibility map to determine the target pixels to be updated in the segmented regions of the initial visibility map comprises:
clustering pixel values of pixels in each of the segmented regions of the initial visibility map to at least obtain: a number of pixels in a first class of pixels and a pixel value of a cluster center of the first class of pixels, and a number of pixels in a second class of pixels and a pixel value of a cluster center of the second class of pixels; and
determining respective target pixels to be updated in the segmented region according to at least one of: a relationship between the number of pixels in the first class of pixels and the number of pixels in the second class of pixels, and a relationship between the pixel value of the cluster center of the first class of pixels and the pixel value of the cluster center of the second class of pixels.

7. The method of claim 6, wherein clustering the pixel values of the pixels in each of the segmented regions of the initial visibility map to at least obtain: the number of pixels in the first class of pixels and the pixel value of the cluster center of the first class of pixels, and the number of pixels in the second class of pixels and the pixel value of the cluster center of the second class of pixels comprises:
mapping pixel values of pixels in the initial visibility map to a specific interval to obtain a first visibility map;
taking the segmented regions of the initial texture map as segmented regions of the first visibility map, and clustering pixels in each of the segmented regions of the first visibility map to at least obtain: the number of pixels in the first class of pixels and the pixel value of the cluster center of the first class of pixels, and the number of pixels in the second class of pixels and the pixel value of the cluster center of the second class of pixels;
accordingly, determining the respective target pixels to be updated in the segmented region according to at least one of: the relationship between the number of pixels in the first class of pixels and the number of pixels in the second class of pixels, and the relationship between the pixel value of the cluster center of the first class of pixels and the pixel value of the cluster center of the second class of pixels comprises:
determining respective target pixels to be updated in the segmented region of the first visibility map according to at least one of: the relationship between the number of pixels in the first class of pixels and the number of pixels in the second class of pixels, and the relationship between the pixel value of the cluster center of the first class of pixels and the pixel value of the cluster center of the second class of pixels;
accordingly, updating the pixel values of the target pixels to be updated in the initial visibility map to obtain the target visibility map comprises:
updating pixel values of target pixels to be updated in the first visibility map to obtain a second visibility map; and
performing, according to a mapping relationship between the initial visibility map and the first visibility map, reverse mapping on pixel values of pixels in the second visibility map to obtain the target visibility map.

8. The method of claim 7, wherein clustering the pixels in each of the segmented regions of the first visibility map further determines non-target pixels of the segmented region; and accordingly,
updating the pixel values of the target pixels to be updated in the first visibility map to obtain the second visibility map comprises:
determining a pixel replacement value of the segmented region according to a pixel value of the non-target pixels of the segmented region of the first visibility map; and
updating pixel values of the target pixels of the segmented region of the first visibility map to the pixel replacement value of the segmented region, so as to obtain the second visibility map.

9. The method of claim 8, wherein determining the pixel replacement value of the segmented region according to the pixel value of the non-target pixels of the segmented region of the first visibility map comprises:
determining a pixel value of a cluster center of the non-target pixels in the segmented region of the first visibility map as the pixel replacement value of the segmented region.

10. The method of claim 8, wherein determining the respective target pixels to be updated in the segmented region of the first visibility map according to at least one of: the relationship between the number of pixels in the first class of pixels and the number of pixels in the second class of pixels, and the relationship between the pixel value of the cluster center of the first class of pixels and the pixel value of the cluster center of the second class of pixels comprises:
determining that the second class of pixels are the target pixels to be updated in the segmented region, in a case that a first operation result of subtracting the pixel value of the cluster center of the second class of pixels from the pixel value of the cluster center of the first class of pixels is greater than or equal to a first threshold value, and a second operation result of dividing the number of pixels in the first class of pixels by the number of pixels in the second class of pixels is greater than or equal to a second threshold value; and
determining that the first class of pixels are the target pixels to be updated in the segmented region, in a case that a third operation result of subtracting the pixel value of the cluster center of the first class of pixels from the pixel value of the cluster center of the second class of pixels is greater than or equal to the first threshold value, and a fourth operation result of dividing the number of pixels in the second class of pixels by the number of pixels in the first class of pixels is greater than or equal to the second threshold value.

11. The method of claim 10, wherein clustering the pixels in each of the segmented regions of the first visibility map to further determine the non-target pixels of the segmented region comprises:
determining that both the first class of pixels and the second class of pixels are the non-target pixels in the segmented region, in a case that the first operation result is less than the first threshold value or the second operation result is less than the second threshold value, and the third operation result is less than the first threshold value or the fourth operation result is less than the second threshold value.

12. The method of claim 10, wherein a value range of the first threshold value is [25, 33], and a value range of the second threshold value is [5, 10].

13. The method of claim 12, wherein the first threshold is 30 and the second threshold is 7.

14. The method of claim 3, wherein obtaining the initial texture map of the target viewport comprises:
performing pruned view reconstruction on atlases of texture maps of the source viewports obtained by decoding a bitstream, to obtain reconstructed texture maps of the source viewports; and
shading, according to the reconstructed texture maps of the source viewports, the initial visibility map of the target viewport to obtain the initial texture map of the target viewport.

15. A rendering method, comprising:
performing pruned view reconstruction on atlases of depth maps of source viewports to obtain reconstructed depth maps of the source viewports;
performing operations in the method of claim 1 on the reconstructed depth maps of the source viewports to obtain a target texture map of a target viewport; and
generating a target view of the target viewport according to the target texture map of the target viewport.

16. A decoding method, comprising:
decoding an input bitstream to obtain atlases of depth maps of source viewports;
performing pruned view reconstruction on the atlases of the depth maps of the source viewports to obtain reconstructed depth maps of the source viewports;
performing operations in the method of claim 1 on the reconstructed depth maps of the source viewports to obtain a target texture map of a target viewport; and
generating a target view of the target viewport according to the target texture map of the target viewport.
